(19) United States
(12) Patent Application Publication
(10) Pub. No.: US 2002/0103333 A1
(43) Pub. Date: Aug. 1, 2002

(54) Latex with decreased allergic reaction and improved physical properties

(76) Inventor: Travis W. Honeycutt, Gainesville, GA (US)

Correspondence Address: Malcolm B. Wittenberg, Esq., Dergosits & Noah LLP, Four Embarcadero Center, Siute 1450, San Francisco, CA, 94111, US

(21) Appl. No.: 09/732,035

(22) Filed: Dec. 6, 2000

(51) Int. Cl. C08J 3/00

(52) U.S. Cl. 528/932; 524/474; 524/498; 524/570; 524/571; 524/572; 524/575.5; 524/768; 524/771; 428/320.2; 428/323; 428/331

(57) ABSTRACT

A method of reducing allergenicity of latex rubber products such as latex rubber gloves. The latex rubber product is treated with first bath of an alkane hydrocarbon followed by a protein substituting material in the form of a synthetic plasticizer. A final wash is carried out using an alkaline or oxidative wash to remove surface and interstice dwelling protein.

### FIELD OF THE INVENTION

This invention relates to products formed from natural rubber latex (“latex”) that come into regular contact with humans, and more particularly to a latex that exhibits decreased allergenicity potential and with improved physical properties.

Competitors have solved the potential for allergic reactions due to protein content but, in the process, have ruined the physical properties that make latex products such as latex gloves so useful. Protein is generally removed using a strong chlorine or hypochlorite wash (Clorox®) which does remove protein, but the latex product is left slick with diminished gripping, elastomeric and tactile properties; it becomes stiff, and in the case of a glove, poor fitting. The glove also exhibits hysteresis and requires a heavy load to stretch the glove to 10% elongation—the result is poor fit and fatigue during use.

### BACKGROUND OF THE INVENTION

Latex allergies can occur in several forms, ranging from nonimmunologically mediated dermatitis from abrasion to contact dermatitis from vulcanization accelerator compounds to immediate hypersensitivity reactions from the latex proteins. The latter presents the most serious problems and can cause urticaria, angioedema, rhinitis, conjunctivitis, bronchospasm and anaphylaxis.

The problems presented by allergic reactions to latex are exacerbated by the proliferation and widespread use of latex based products. Latex presents great risk to persons in the health care industry where latex products are used extensively in the form of gloves, casts, dressings, tapes, catheters, tubes, drains, airway management devices, med delivery, tourniquets, monitoring devices, and others. One persistent threat lies in the cornstarch powder used to lubricate and ease donning of rubber gloves. The proteins absorb onto the powder and become aerosolized during use and when the gloves are donned and removed.

Products containing latex are also found throughout the home in the form of balloons, art supplies, toys, swimming equipment, contraceptive devices, cosmetics, bottle nipples, pacifiers, clothing, chewing gum, rubber bands, and others. Groups at risk include particularly children with spina bifida, who have been shown to have a very high risk of latex sensitivity, patients with congenital urologic abnormalities, healthcare providers and rubber industry workers.

Since the severe allergic reactions to latex are due to their naturally occurring proteins, the prior art offers little in the way of solutions. For example, “hypoallergenic” latex products are free from the vulcanization accelerator compounds that can cause dermatitis, but do not prevent immediate hypersensitivity reactions. Likewise, ammonia treatment of the natural rubber latex proteins can cause breakdown and precipitation of some latex proteins, but the allergenicity appears to be preserved and other antigenic latex proteins are unextractable. In short, the literature recommends that the only treatment available for latex allergy is avoidance.

The Food and Drug Administration (FDA), as well as other state and federal agencies, has received requests to ban the use of glove powder. It has been suggested that experimental and clinical studies demonstrate that glove powder on medical gloves can enhance foreign body reactions, increase infections and act as a carrier of natural latex allergens. The National Institute of Occupational Safety and Health (NIOSH) recently issued a safety alert recommending the use of powder-free, reduced protein content latex gloves to reduce exposure to natural latex proteins (allergens).

Experimental and clinical data demonstrate that natural rubber latex (NRL) proteins are allergenic. Further, natural latex proteins bind to cornstarch while aerosolized powder on NRL gloves is allergenic and can cause respiratory allergic reactions. Published studies support the conclusion that airborne glove powder represents a threat to individuals allergic to natural rubber latex and may represent an important agent for sensitizing non-allergic individuals. There are also published data (although limited) and clinical experience that cornstarch powder on NRL gloves may also be a contributing factor in the development of irritation and Type IV allergy.

In addition to dusting powder, other lubricants may also be used in the manufacturing process. Latex and some polymers are tacky and gloves made of these materials stick to the mold or former. A mold-release lubricant such as calcium carbonate or a mixture of calcium carbonate and cornstarch is used to enable the removal of gloves from molds. The other side of the glove may be coated with a donning lubricant, such as cornstarch or silicone oils, to make donning gloves easier and to prevent gloves from sticking during the manufacturing process.

Over the past three years, the FDA has received requests to ban the use of all glove powders. These requests have been based on repeated clinical and experimental studies reporting that cornstarch on surgical gloves can damage tissue's resistance to infection, enhance the development of infection, serve as a potential source of occupational asthma, and provide a source of natural latex protein exposure to natural latex allergic individuals. The issues regarding the use of glove powder, except for the transport of natural latex protein allergens, apply to the use of glove powder on both natural rubber latex and synthetic gloves. Several states, acting on their own initiative have banned the sale and use of glove powders.

Thus, an object of the present invention is to teach a method of rendering a latex product, such as a glove, powder free while exhibiting decreased allergenicity with no loss of physical properties and improved performance in use.

These and other objects will become more readily apparent when considering the following disclosure and appended claims.

### SUMMARY OF THE INVENTION

The present invention deals with a method of treating a preformed latex article as well as the latex article so treated. As noted above, in practicing the present method, the latex article exhibits decreased protein content and hence decreased allergenicity with no substantial loss of physical properties and in some instances enhanced physical properties.

The present method deals with a latex rubber article that has been treated with a protein substituting material (synthetic plasticizers) that “invade” the amorphous and crystalline areas of the formed and/or cured latex rubber article and thereby substitutes for the natural plasticizers (proteins) or rubber elongation factor (REF) as they are also known.

Protein substitution is followed by an alkaline oxidation wash to remove surface and/or interstices dwelling protein. The result is a latex article with greatly reduced protein levels and sustained or improved physical properties.

### DETAILED DESCRIPTION OF THE INVENTION

Latex is a rubber product obtained from Brazilian rubber trees. Latex sap is collected from the trees, ammoniated, and concentrated. The treated rubber may then be vulcanized by heating in the presence of sulfur to improve such physical characteristics of the latex as elasticity, strength and stability. Latex comprises 1,4-cis polyisoprene, water, lipids and about 5% by weight proteins such as prenyl transferase and rubber elongation factor (REF). These proteins can polymerize the isoprene to molecular weights in excess of 100,000 D.P., but are responsible for severe allergic reactions.

Latex is an extremely useful form of rubber characterized by its elasticity. Latex can be found in a myriad of products ranging from the health care industry (gloves, intravenous devices, respiratory devices, catheters, surgical devices, dental devices and nursing supplies) to consumer products (rubber bands, toys, balloons, foam rubber, elastic in clothing, pacifiers, nipples, sports equipment, and craft supplies). Because latex is so prevalent, persons having sensitivity to latex have a very difficult time avoiding exposure. Unfortunately, avoidance is the only method of treatment know in the art.

This invention comprises a natural latex rubber and articles made of natural latex rubber that exhibit reduced allergenicity. This result is achieved by employing, as a starting point, a latex rubber that has been ammoniated, washed and concentrated by conventional methods to prepare a latex article such as a glove, balloon, catheter or other device. The article is then pretreated in a bath containing, for example, a mineral oil (alkane hydrocarbon) alone or in combination with silicone oil and can include commonly known plasticizers such as phthalate esters, etc. The latex article is then allowed to stand and the oil will substitute for the protein in the article. The protein then can be washed away and destroyed in an oxidizing bath such as a hydrogen peroxide bath containing soda ash or a very dilute sodium hypochlorite wash. Auxiliary agents such as wetting agents can be employed as needed.

Once the latex rubber has been subjected to the above-noted oxidizing wash, for approximately ten to thirty minutes, the product is dried preferably under ambient conditions or centrifugally dried. The article can then be “finished” in a conventional manner with cornstarch or silicone emulsion to improve donning properties if needed. However, in most cases, further finishing is not required. The resulting product is a clear, white, non-yellowing latex that has low modulus, high elasticity and is reasonably completely free of any residual protein content and does not exhibit hysterisis.

It is preferable that the “pretreatment” be of a heavy mineral oil type but other akyls, alkanes and silicone oils are not excluded and of particular interest are alkane substituted esters such as phthalates as plasticizer additives.

In order to demonstrate the improved characteristics of latex articles such as gloves which are not only clear, white and non-yellowing but are reasonably completely free of detectable proteins, the following studies were conducted.

As a starting point, Vystar's untreated Supernatural Exam Gloves were measured for physical characteristics as well as protein content as follows:

| | | | | | Lowry | | | |
|---|---|---|---|---|---|---|---|---|
| | | | Sample | Extract | Assay | | Total Protein | |
| | | Glove Sample | Weight | Volume | Conc. | Surface | Concentration | |
| Sample # | LTS # | Identification | (g) | (ml PBS) | (ug/ml) | Area | (ug/g) | (ug/dm2) |
| 1 | 16982a | Vystar, | 8.4 | 25 | 26 | 10.1 | 78 | 65 |
| | | Supernatural | | | | | | |
| | | Lot Untreated | | | | | | |
| 2 | b | Vystar, | 8.5 | 26 | 30 | 10.1 | 90 | 76 |
| | | Supernatural | | | | | | |
| | | Lot Untreated | | | | | | |

It was next determined if a means could be developed to reduce the protein level in natural latex rubber exam gloves to “non-detectable” levels by performing alterations “post” manufacture, after the gloves are formed, cured and powdered. The results of this procedure were determined by an independent laboratory analysis using Lowry Assay per ASTM D5712-95 protocol.

Nine natural rubber latex gloves (Supreme style from Semperit) were rinsed in water to remove the cornstarch and then dried at room temperature. The nine gloves weighed 99 grams and were treated with 5.5 grams of heavy mineral oil (Aldrich; Product No. 33076-0) and two grams of silicone oil (Aldrich; Product No. 14615-3) for five minutes by rolling and were allowed to stand for forty-five minutes covered.

The gloves were then washed twice in a bath containing 200 milligrams of Clorox® brand bleach and 1,800 milligrams of water. In the second wash, 2 grams of OSI Specialties Silicon Emulsion 45 was added as a “downing” agent. The gloves were allowed to dry and were submitted for testing. LEAP assays were below detection and Antigenic Protein Concentrations were less than 0.2 mg/g. The elastomeric properties were much improved with a 10% reduction in initial modulus.

The tests were repeated on Semperit's DERMA style gloves with the same results.

The tests were repeated on Semperit's exam gloves using the same procedure with the same results—no detectable protein.

The tests were repeated using a mineral oil emulsion in combination with the Clorox® brand bleach wash solution with the same results—no detectable protein.

what is claimed is:

1. A method of reducing allergenicity of latex rubber by reducing protein levels found within said latex rubber, said method comprising subjecting said latex rubber to a first wash of an alkane hydrocarbon followed by treating said latex rubber with a protein substituting material in the form of a synthetic plasticizer followed by an alkaline or oxidative final wash to remove surface and interstice dwelling protein.

2. The method of claim 1 wherein said alkane hydrocarbon comprises mineral oil.

3. The method of claim 1 wherein said synthetic plasticizer comprises a phthalate ester.

4. The method of claim 1 wherein said final wash is carried out with an alkaline peroxide.

5. The method of claim 1 wherein the latex rubber is treated with cornstarch or silicon emulsion after said final wash to improve its donning properties.

6. The method of claim 1 wherein said latex rubber is configured into latex gloves.

7. The method of claim 1 wherein said latex rubber is in the form of a pair of latex rubber gloves exhibiting reduced allergenicity, said latex rubber gloves being produced by treating them with a first bath of an alkane hydrocarbon followed with a protein substituting material in the form of a synthetic plasticizer followed by an alkaline or oxidative final wash to remove surface and interstice dwelling protein.

8. The method of claim 7 wherein the latex rubber gloves are treated with cornstarch or silicon emulsion after said final wash to improve their donning properties.
